(19) United States
(12) Patent Application Publication
(10) Pub. No.: US 2025/0148713 A1
(43) Pub. Date: May 8, 2025

(54) SELECTING BLOCKS TO REPRESENT SCENE

(71) Applicant: Google LLC, Mountain View, CA (US)

(72) Inventors: Kathryn Heal, Los Angeles, CA (US); John Patrick Flynn, Los Angeles, CA (US); Ryan Styles Overbeck, Mountain View, CA (US); Michael Joseph Broxton, Los Gatos, CA (US); Stephen Anthony Lombardi, Seattle, WA (US); Clément Louis Jean-Claude Godard, San Francisco, CA (US)

(21) Appl. No.: 18/500,700

(22) Filed: Nov. 2, 2023

(51) Int. Cl. G06T 17/20; G06T 15/08

(52) U.S. Cl. CPC G06T 17/20; G06T 15/08

(57) ABSTRACT

A non-transitory computer-readable storage medium comprises instructions stored thereon. When executed by at least one processor, the instructions are configured to cause a computing system to at least generate multiple mesh cells based on multiple mesh layers, the multiple mesh layers representing a volumetric scene, the multiple mesh cells including multiple mesh blocks; select, from the multiple mesh blocks, k selected blocks based on densities of the multiple mesh blocks, k being a predetermined number; and store the selected blocks and identifiers of locations of the selected blocks.

### TECHNICAL FIELD

This description relates to image or scene representation.

### BACKGROUND

Images or scenes can be represented by various protocols. The storage of the images or scenes consumes computing resources such as memory.

### SUMMARY

A volumetric scene is represented by blocks. Some of the blocks correspond to locations with empty space and include little information. To reduce memory storing the volumetric scene, a predetermined number of blocks are selected, and non-selected blocks are discarded and/or deleted. The selected blocks can be stored as a data structure that represents the volumetric scene.

According to an example, a non-transitory computer-readable storage medium comprises instructions stored thereon. When executed by at least one processor, the instructions are configured to cause a computing system to at least generate multiple mesh cells based on multiple mesh layers, the multiple mesh layers representing a volumetric scene, the multiple mesh cells including multiple mesh blocks; select, from the multiple mesh blocks, k selected blocks based on densities of the multiple mesh blocks, k being a predetermined number; and store the selected blocks and identifiers of locations of the selected blocks.

According to an example, a method includes generating multiple mesh cells based on multiple mesh layers, the multiple mesh layers representing a volumetric scene, the multiple mesh cells including multiple mesh blocks; selecting, from the multiple mesh blocks, k selected blocks based on densities of the multiple mesh blocks, k being a predetermined number; and storing the selected blocks and identifiers of locations of the selected blocks.

According to an example, a computing system comprises at least one processor and a non-transitory computer-readable storage medium. The non-transitory computer-readable storage comprises instructions stored thereon that, when executed by the at least one processor, are configured to cause the computing system to at least generate multiple mesh cells based on multiple mesh layers, the multiple mesh layers representing a volumetric scene, the multiple mesh cells including multiple mesh blocks; select, from the multiple mesh blocks, k selected blocks based on densities of the multiple mesh blocks, k being a predetermined number; and store the selected blocks and identifiers of locations of the selected blocks.

The details of one or more implementations are set forth in the accompa-nying drawings and the description below. Other features will be apparent from the description and drawings, and from the claims.

### BRIEF DESCRIPTION OF THE DRAWINGS

FIG. 1 is a flowchart showing a method of generating a data structure that represents a volumetric scene and re-creating the volumetric scene based on the data structure.

FIG. 2A shows a representation of a volumetric scene.

FIG. 2B shows layers representing the volumetric scene of FIG. 2A.

FIG. 2C shows blocks generated from the layers of FIG. 2B.

FIG. 2D shows selection of k of the blocks from FIG. 2C.

FIG. 2E shows the selected k blocks.

FIG. 3 shows a transformation from a layer that represents a volumetric scene to a data structure that includes k selected blocks.

FIG. 4 shows a transformation from the data structure that includes the k selected blocks to a layer, with non-selected blocks having a predetermined value.

FIG. 5 shows a transformation from the data structure that includes the k selected blocks to a layer, the addition of information to the selected blocks, and a data structure that includes the k selected blocks with the additional information.

FIG. 6 shows a pipeline for encoding and decoding a volumetric scene that includes a data structure with k selected blocks.

FIG. 7 shows a pipeline for representing a volumetric scene with k selected blocks.

FIGS. 8A and 8B show a pipeline for performing convolution on selected blocks.

FIG. 9 shows rescaling blocks to change resolution of the blocks.

FIG. 10 shows a computing system.

FIG. 11 is a flowchart of a method.

Like reference numbers refer to like elements.

### DETAILED DESCRIPTION

A volumetric scene can include a three-dimensional scene captured by one or more cameras and/or time-of-flight sensors. The volumetric scene can be represented and/or stored as mesh layers and/or mesh blocks. The mesh layers and/or mesh blocks and be passed through a neural network model for realistic rendering of the subject of the scene. A technical problem with representing the volumetric scene as mesh layers and/or mesh blocks is that portions of the mesh layers and/or some of the mesh blocks represent empty space. The representation of empty space conveys little to no information, which wastes computing resources such as memory for storage, as well as processing resources for processing empty or inactive blocks.

A technical solution to the technical problem of portions of the mesh layers and/or some of the mesh blocks representing empty space is to select a predetermined number, k, blocks, to represent the volumetric scene. The blocks can be selected based on scores, which can be based on density and/or existence of an object within the volume of space associated with the blocks. The selected blocks convey information—the existence and/or shape of an object within the volume of space associated with the blocks. A technical benefit to this technical solution is to reduce the number of blocks stored to represent the volumetric scene, thereby decreasing the computing sources such as memory consumed by the representation of the volumetric scene, while maintaining most of the information to recreate the volumetric scene.

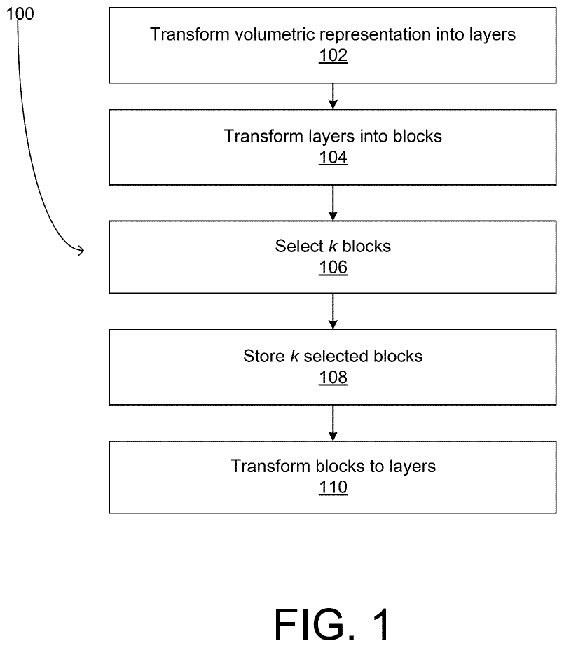

FIG. 1 is a flowchart showing a method of generating a data structure that represents a volumetric scene and re-creating the volumetric scene based on the data structure. A volumetric scene can be a physical scene represented in three dimensions, such as x, y, and z orthogonal coordinates in a linear or Cartesian representation, or horizontal angle, vertical angle, and distance from a point in polar coordinates. The representation can include values associated with points within the coordinate system. The values can be binary values indicating existence or non-existence of an object or portion of an object, and/or values of properties such as color, opacity, or density.

The method 100 can include transforming the volumetric scene into layers (102). The transformation of the volumetric scene into layers (102) can include generating layers based on the volumetric scene. The transformation of the volumetric scene into layers (102) can include transforming the volumetric scene into mesh layers. Mesh layers can each be a different distance from a point such as a point in space where a camera captured one or more images of the scene, or have different values for one of the coordinates (such as x, y, and z in the linear or Cartesian representation or horizontal angle, vertical angle, or distance from a point in polar coordinates).

Mesh layers can include representations of objects within a “slice” or range of the distance from the point or values for the coordinate. In some implementations, the representations of the objects within a mesh layer can be in two dimensions, indicating the presence or absence of an object, and/or values for the object (such as color or density), for areas within the mesh layer. In some implementations, representations of the objects within a mesh layer can be in three dimensions, indicating the presence or absence of an object, and/or values for the object (such as color or density), for areas within the mesh layer. The indications of presence or absence of objects, and associated values, can be based on points within the respective mesh layers, or two- or three-dimensional shapes within the respective mesh layers.

After the transformation of the volumetric scene into layers (102), the method 100 can include transforming the layers into blocks (104). The transforming layers into blocks (104) can include generating blocks from the layers. The transforming layers into blocks (104) can include transforming the layers into cells, and dividing the cells into blocks. The cells can be divided into blocks by applying a grid, such as a two-dimensional grid, to the cells. The grids can be predetermined sizes, such as 16-by-16 grids or 4-by-4 grids. The cells can be divided into a predetermined number of cells based on the grid size, such as dividing the cells into sixty-four equally-sized blocks or sixteen equally-sized blocks.

The method 100 can include selecting k blocks (106). The k blocks that are selected can be blocks that have highest scores among the blocks into which the layers were transformed. The scores can be based, for example, on density or occupation of the blocks by one or more objects. The value of k can be preselected and/or predetermined. The value of k can be, for example, between one percent (1%) and ninety percent (90%) or between one percent (1%) and ten percent (10%) of the total number of blocks into which all of the layers were transformed. The selection of the k blocks can be independent of the layers and/or cells from which the blocks were generated and/or transformed. The number of blocks selected can be different for different layers and/or cells.

The method 100 can include storing the k selected blocks (108). The selected blocks can be stored in association with attributes of the selected blocks. In some implementations, the attributes include locations of the blocks, such as an integer array with a depth, row, and/or column indicating the block location. In some implementations, the attributes can include a block size, such as a height and/or width of the block. In some implementations, the attributes can include full dimensions of the blocks, such as a number of layers, height, and/or width of a larger tensor or representation of the volumetric scene that the blocks index to. In some implementations, the attributes can include the scores of the blocks.

The method 100 can include transforming the blocks back to layers (110). The transformation of the blocks back to layers (110) can include generating layers based on the blocks. The transforming the blocks back to layers (110) can include generating multiple new layers and/or multiple new mesh layers based on the blocks. The layers that are generated based on the blocks can be considered new layers and/or new mesh layers. The layers can be different distances from a reference point, similar to the layers generated in the transformation into layers (102). The layers into which the blocks are transformed can include mesh layers. The transformation of the blocks back to layers (110) enables the presentation of the original volumetric scene. In some implementations, transformation of the blocks back to layers (110) includes generating mesh blocks with predetermined values for mesh blocks that do not correspond to the selected and stored blocks. The predetermined values can be fill values or empty values for the blocks that were not selected. In some implementations, transformation of the blocks back to layers (110) includes generating mesh blocks with predetermined values and/or fill values for mesh blocks that do not correspond to the selected and stored blocks.

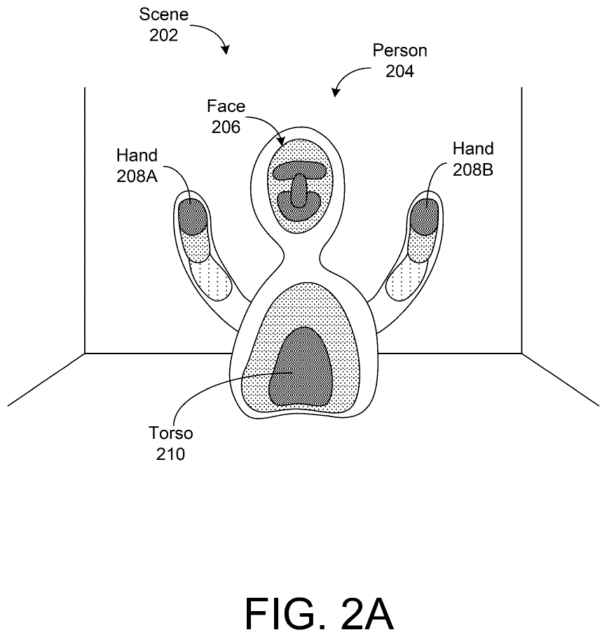

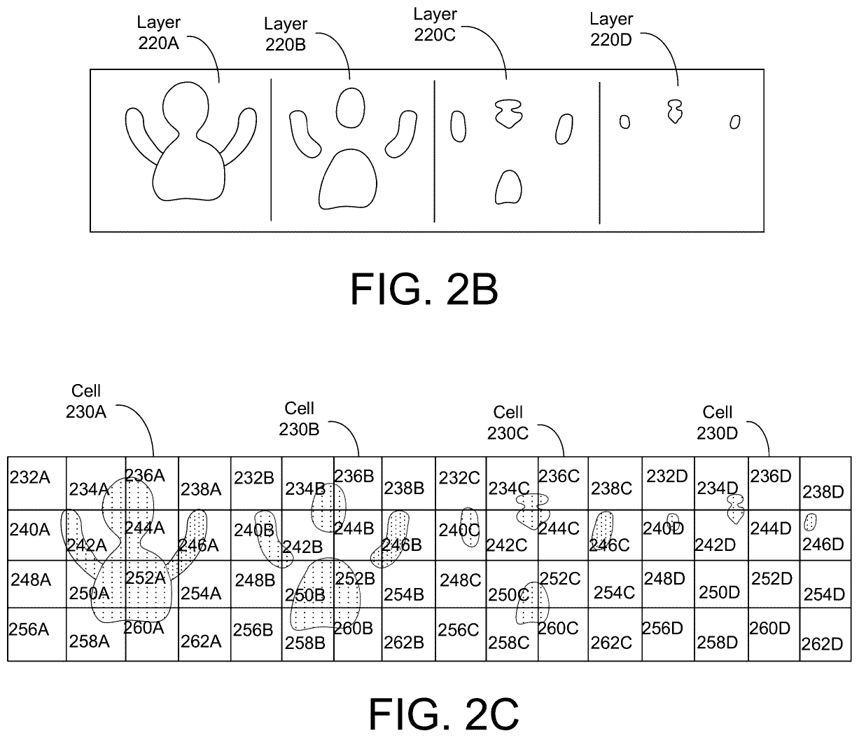

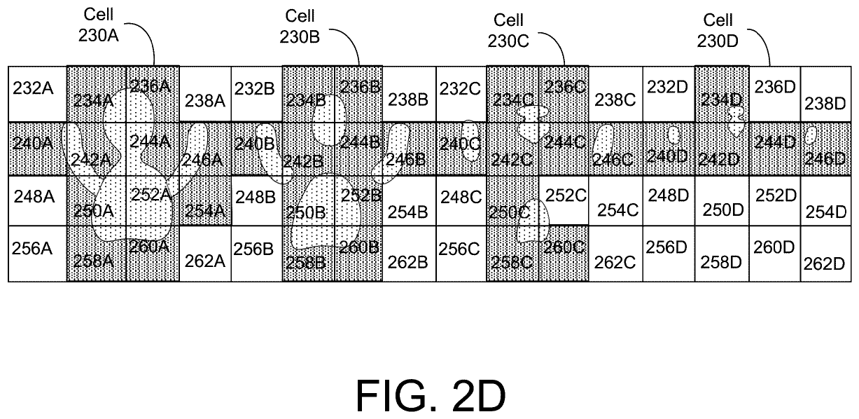

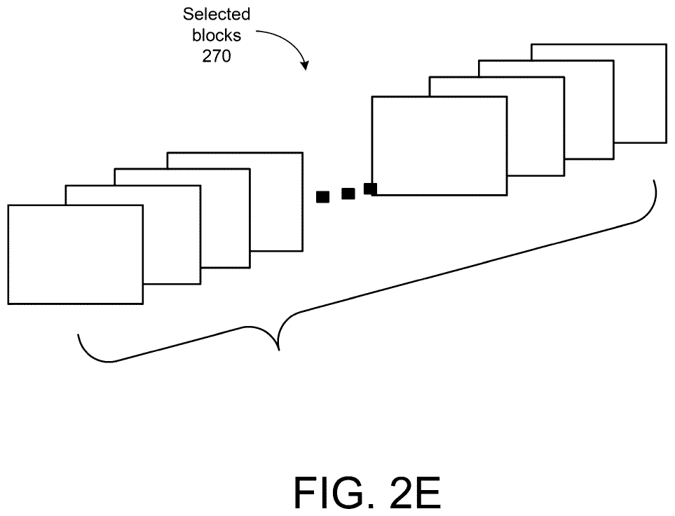

FIG. 2A shows a representation of a volumetric scene 202. The volumetric scene 202 can represent and/or display one or more objects in three-dimensional, physical space. In some examples, the three dimensions can be represented in orthogonal, Cartesian coordinates, such as x, y, and z. The orthogonal Cartesian coordinates can represent distances from a point in orthogonal directions. In some examples, the three dimensions can be represented in polar coordinates, such as a horizontal angle from a direction extending from a point or plane, a vertical angle from a direction extending from a point or plane (the plane would be orthogonal to the plane from which the horizontal angle extends), and a distance from the point.

In the example shown in FIG. 2A, the object represented within the volumetric scene 202 is a person 204. The person 204 has a face 206, a right hand 208A at an end portion of a right arm (not labeled), a left hand 208B at an end portion of a left arm (not labeled), and a torso 210. In the representation of the person 204, depth is represented by density of the color or shading. For example, the nose on the face 206 is shown with dense color or shading to indicate that the nose protrudes forward toward the viewer. Foe example, the hands 208A, 208B are shown with dense color or shading to indicate that the hands 208A, 208B are closer to the viewer than other portions of the arms. For example, a center portion of the torso 210 is shown with dense color or shading to indicate that a center portion of a stomach of the person 204 extends toward the viewer.

The volumetric scene 202 can be considered a dense layers representation of the object. The representation of the object (the person 204 in the example of FIG. 2A) can be represented by points in orthogonal dimensions such as depth (D), height (H), width (W), as well as one or more channels (C). The channels can describe qualities of the points. The channels and/or qualities can include, for example, opacity and/or color of the points.

The volumetric scene 202 can be transformed into layers, such as mesh layers. The transformation of the volumetric scene 202 into layers can be considered generation of layers based on the volumetric scene 202.

FIG. 2B shows layers 220A, 220B, 220C, 220D representing the volumetric scene 202 of FIG. 2A. The multiple layers 220A, 220B, 220C, 220D can be multiple mesh layers representing the volumetric scene 202. The layers 220A, 220B, 220C, 220D each represent a different depth of the volumetric scene 202. The layers 220A, 220B, 220C, 220D can represent slices, or depth ranges, of the person 204. For example, the layer 220A shows the back of the head, torso, and arms of the person 204 that are all present at a first distance from a point of reference viewing the volumetric scene 202. The layer 220B shows the portion of the head, lower arms, and torso that are closer to the point of reference, but not the upper arms or neck. The layer 220C shows the furthest-extending portion of the stomach or torso, hands, and furthest-extending portions of the face 206. The layer 220D shows only the hands 208A, 208B and furthest-extending portions of the face 206.

FIG. 2C shows blocks generated from the layers of FIG. 2B. The layers 220A, 220B, 220C, 220D can be downsampled into blocks. The multiple blocks, which can be mesh blocks, can make up multiple cells, which can be mesh cells. Blocks 232A to 262A can make up a first cell 230A, blocks 232B to 262B can make up a second cell 230B, blocks 232C to 262C can make up a third cell 230C, and blocks 232D to 262D can make up a fourth cell 230D. The cells 230A, 230B, 230C, 230D are divided into grids of blocks. In some examples, the cells 230A, 230B, 230C, 230D are divided into 16-by-16 grids of 256 blocks. In some examples, the cells 230A, 230B, 230C, 230D are divided into 4-by-4 grids of 16 blocks. Each block can include a portion of the layer from which the cell that includes the respective block was downsampled. Block 246A includes a representation of a rear portion of the left hand 208B, block 234D includes a portion of the representation of the nose included in the face 206, and block 240D includes a representation of a front portion of the right hand 208A.

A computing system can select k blocks from the cells 230A, 230B, 230C, 230D. The number k can be predetermined based on multiple volumetric scenes, and will be less than the total number of blocks but greater than zero. A higher value for k improves the resulting image quality but reduces memory savings. A lower value for k increases memory savings but reduces the resulting image quality.

FIG. 2D shows selection of k of the blocks from FIG. 2C. In the example of FIG. 2D, the value of k is 34. The 34 blocks, 234A, 236A, 240A, 242A, 244A, 246A, 250A, 252A, 254A, 258A, 260A, 234B, 236B, 240B, 242B, 244B, 246B, 250B, 252B, 258B, 260B, 234C, 236C, 240C, 242C, 244C, 246C, 250C, 258C, 260C, 234D, 240D, 242D, 244D, 246D are selected based on having highest scores. The scores for the blocks can be determined based on densities of the blocks. In some implementations, the scores are based on numbers of points within the block that indicate presence of an object. In some implementations, the scores are based on points that indicate presence of an object and values of attributes for the points. The values of the attributes can indicate color or opacity, for example. In some implementations, darker colors for points can contribute to higher scores for blocks than lower scores. In some implementations, more opaque points can contribute more to scores than translucent points. The k (e.g. 34) blocks, 234A, 236A, 240A, 242A, 244A, 246A, 250A, 252A, 254A, 258A, 260A, 234B, 236B, 240B, 242B, 244B, 246B, 250B, 252B, 258B, 260B, 234C, 236C, 240C, 242C, 244C, 246C, 250C, 258C, 260C, 234D, 240D, 242D, 244D, 246D that are selected can be considered the selected blocks. The remaining blocks 232A, 238A, 248A, 256A, 262A, 232B, 238B, 248B, 254B, 256B, 262B, 232C, 238C, 248C, 252C, 254C, 256C, 262C, 232D, 236D, 238D, 248D, 250D, 252D, 254D, 256D, 258D, 260D, 262D that were not selected can be considered non-selected blocks.

FIG. 2E shows the selected k blocks. The selected blocks 270 can be the blocks, 234A, 236A, 240A, 242A, 244A, 246A, 250A, 252A, 254A, 258A, 260A, 234B, 236B, 240B, 242B, 244B, 246B, 250B, 252B, 258B, 260B, 234C, 236C, 240C, 242C, 244C, 246C, 250C, 258C, 260C, 234D, 240D, 242D, 244D, 246D selected based on having highest scores. The selected blocks 270 can be a data structure with a predetermined size. The predetermined size can be based on the predetermined value for k. The predetermined size can improve efficiency of allocation of memory to store the selected blocks 270. The blocks within the selected blocks 270 can have values identifying a number of the block (such as 0 to k−1) and/or locations within the cells 230A, 230B, 230C, 230D and/or volumetric scene 202. In some implementations, the blocks have channel values. In some implementations, the channel values indicate colors of the blocks. In some implementations, the channel values indicate opacity of the blocks. In some implementations, the channel values indicate the scores determined for the blocks.

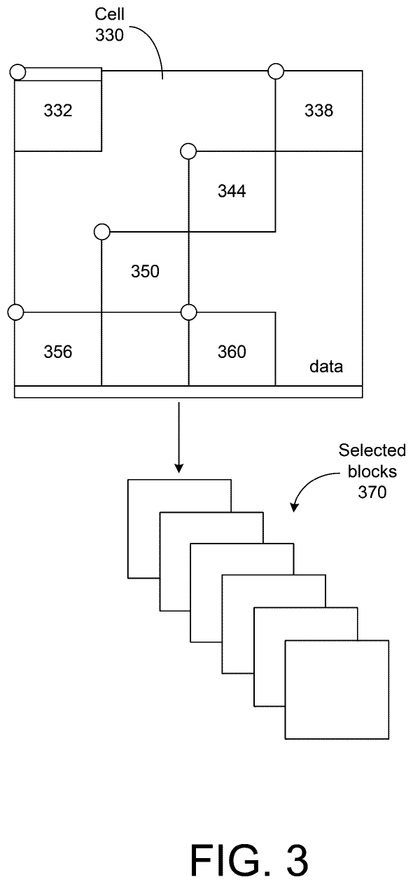

FIG. 3 shows a transformation from a layer that represents a volumetric scene to a data structure that includes k selected blocks. The layer is represented in FIG. 3 by a cell 330. The data structure that includes the k selected blocks is represented by selected blocks 370. A computing system generates the selected blocks 370 based on the cell 330 and attributes of the selected blocks. The cell 330 can have similar features and/or values as the cells 230A, 230B, 230C, 230D described above.

The generation of the selected blocks 370 based on the cell 330 can include executing a function that receives as arguments dense layer data, such as the volumetric scene 202, layers 220A, 220B, 220C, 220D and/or cells 230A, 230B, 230C, 230D, as well as specifications and/or attributes of the blocks. In some implementations, the specifications and/or attributes include locations of the blocks. In some implementations, the locations of the blocks are identified by integer arrays, such as depth, row, and column identifiers of the locations of the blocks. In some implementations, the specifications and/or attributes include block sizes. The block sizes can indicate heights and widths of the blocks. In some implementations, the specifications and/or attributes include dimensions of a tensor representing the volumetric scene 202 into which the blocks index. The dimensions of the tensor can include a number of the layers (such as the layers 220A, 220B, 220C, 220C), the height of the layers, tensor, and/or volumetric scene 202, and/or the width of the layers, tensor, and/or volumetric scene 202. In some implementations, the specifications and/or attributes include scores of the blocks. The scores of the blocks were the scores based on which the blocks with the k highest scores were selected. In some implementations, the specifications and/or attributes include a ranking of the blocks. The rankings of the blocks can be based on the scores of the blocks in either ascending order or descending order.

In the example shown in FIG. 3, blocks 332, 338, 344, 350, 356, 360 are selected blocks. The blocks 332, 338, 344, 350, 356, 360 were selected from among multiple cells based on having scores that are among the highest k scores from blocks among the multiple cells representing the volumetric scene 202. The computing system may have generated the scores based on densities of the cells (such as number of points representing presence of an object) and/or values associated with points within the cells. The values associated with points within the cells can indicate opacity or color, as non-limiting examples.

The selected blocks 370 can have similar values and/or features as the selected blocks 270. The computing system can store the selected blocks 370 as a data structure. The data structure of the selected blocks 370 has a predictable and/or predetermined size based on the predetermined number k of blocks that were selected. The predictable and/or predetermined size of the data structure of the selected blocks 370 assists in the allocation of storage for the selected blocks 370.

The computing system can generate layers and/or cells based on the selected blocks. The generation of layers and/or cells based on the selected blocks can be considered a transformation of the selected blocks into the layers and/or cells. The generated layers and/or cells can include mesh layers. In some implementations, to generate values for blocks within the layers and/or cells that do not correspond to the selected blocks, the computing system can assign predetermined values and/or fill values to the blocks within the layers and/or cells that do not correspond to the selected blocks. The assignment of predetermined values and/or fill values to the blocks within the layers and/or cells that do not correspond to the selected blocks enables the computing system to recreate the volumetric scene 202 based only on the selected blocks.

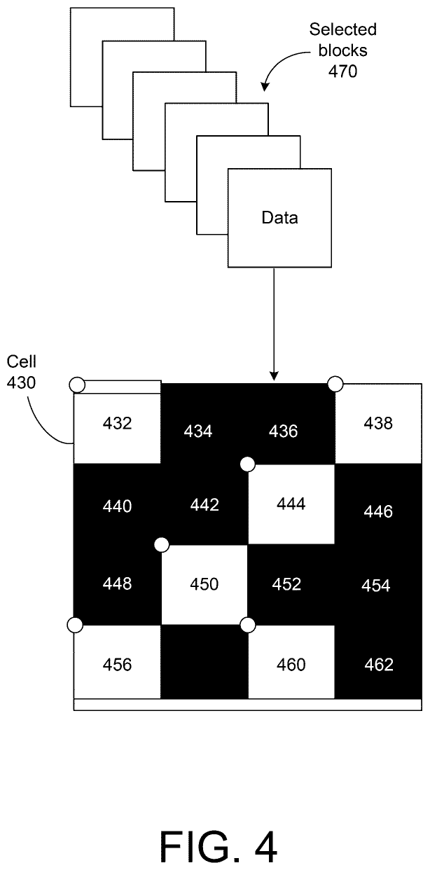

FIG. 4 shows a transformation from the data structure that includes the k selected blocks 470 to a layer, with non-selected blocks having a predetermined value. The selected blocks 470 can have similar values and/or features as the selected blocks 270, 370 described above.

The computing system can generate blocks within a cell 430. The cell 430 can have similar features to the cells 230A, 230B, 230C, 230D, 330 described above. Blocks 432, 438, 444, 450, 456, 460 within the cell 430 that correspond to the selected blocks 470 can include, store, and/or be associated with values directly copied from, and/or included, stored, and/or be associated with the selected blocks 470.

Blocks 434, 436, 440, 442, 446, 448, 452, 454, 458, 462 that do not correspond to the selected blocks 470 do not initially have values. To provide values to the blocks 434, 436, 440, 442, 446, 448, 452, 454, 458, 462, and/or to generate the blocks 434, 436, 440, 442, 446, 448, 452, 454, 458, 462, the computing system can add and/or provide predetermined values and/or fill values to the blocks 434, 436, 440, 442, 446, 448, 452, 454, 458, 462. The computing system can generate the cell 430, and/or transform the selected blocks 470 into the cell 430, based on the selected blocks 470, specifications and/or attributes of the selected blocks 470, and the predetermined value or fill value.

In some implementations, the specifications and/or attributes based on which the cell 430 is generated include locations of the blocks. In some implementations, the locations of the blocks are identified by integer arrays, such as depth, row, and column identifiers of the locations of the blocks. In some implementations, the specifications and/or attributes include block sizes. The block sizes can indicate heights and widths of the blocks. In some implementations, the specifications and/or attributes include dimensions of a tensor representing the volumetric scene 202 into which the blocks index. The dimensions of the tensor can include a number of the layers (such as the layers 220A, 220B, 220C, 220C), the height of the layers, tensor, and/or volumetric scene 202, and/or the width of the layers, tensor, and/or volumetric scene 202. In some implementations, the specifications and/or attributes include scores of the blocks. The scores of the blocks were the scores based on which the blocks with the k highest scores were selected. In some implementations, the specifications and/or attributes include a ranking of the blocks. The rankings of the blocks can be based on the scores of the blocks in either ascending order or descending order.

The fill values or predetermined values can be predetermined before the generation of the cell 430. In some implementations, the fill values or predetermined values are empty values indicating lack of objects. In some implementations, the fill values or predetermined values are colors corresponding to a background of the volumetric scene 202. In some implementations, a computing system can determine the fill values or predetermined values when generating the layers 220A, 220B, 220C, 220D based on the volumetric scene 202, when generating the cells 230A, 230B, 230C, 230D based on the layers 220A, 220B, 220C, 220D, and/or when selecting the blocks 270.

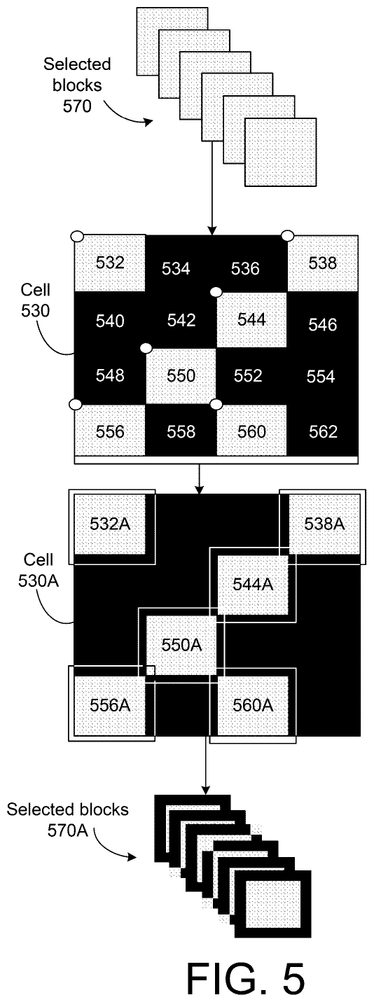

FIG. 5 shows a transformation from the data structure that includes the k selected blocks to a layer, the addition of information to the selected blocks, and a data structure that includes the k selected blocks with the additional information. Selected blocks 570 can have similar features to the selected blocks 470. A cell 530 can have similar features to the cell 530. The computing system can generate the cell 530 based on the selected blocks 570, and/or transform the selected blocks 570 into the cell 530, in a similar manner to the transformation of the selected blocks 470 into the cell 430. Blocks 532, 538, 544, 550, 556, 560 correspond to the selected blocks 570. Blocks 534, 536, 540, 542, 546, 548, 552, 554, 558, 562 do not correspond any of to the selected blocks 570.

The computing system can generate a dilated cell by dilating the blocks 532, 538, 544, 550, 556, 560 that correspond to the selected blocks 570. Dilation of the blocks 532, 538, 544, 550, 556, 560 can expand sizes of the blocks 532, 538, 544, 550, 556, 560. Expansion of the sizes of the blocks 532, 538, 544, 550, 556, 560 can include increasing the height and/or width of the blocks 532, 538, 544, 550, 556, 560. The additional portions of the blocks 532, 538, 544, 550, 556, 560 can include a fill value and/or predetermined value. In some implementations, the fill value and/or predetermined value has a same and/or similar feature as the fill value and/or predetermined value used to generate the blocks 434, 436, 440, 442, 446, 448, 452, 454, 458, 462 that do not correspond to selected blocks.

The computing system can generate dilated selected blocks 570A based on the selected blocks 532A, 538A, 544A, 550A, 556A, 560A within the cell 530A that were dilated. The dilated selected blocks 570A can have similar features (such as specifications and/or attributes) to the selected blocks 570 with increased size (such as increased height and/or increased width). The expanded and/or dilated portions of the selected blocks 570A and/or selected blocks 532A, 538A, 544A, 550A, 556A, 560A can include the predetermined value and/or fill value discussed above with respect to the cell 430. The computing system can store the dilated selected blocks 570A as a data structure for later reconstruction of the volumetric scene 202.

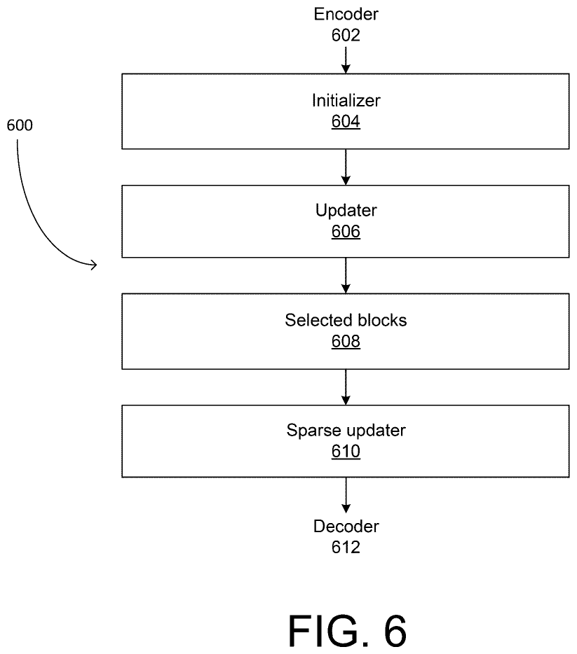

FIG. 6 shows a pipeline 600 for encoding and decoding a volumetric scene that includes a data structure with k selected blocks. The pipeline 600 can be implemented as a neural network model. An encoder 602 can generate the volumetric scene 202. The encoder 602 can be included in a computing system. The encoder 602 can generate the volumetric scene 202 based on images captured and/or generated by one or more cameras and/or time-of-flight sensors. The cameras and/or time-of-flight sensors can capture the image(s) from a single point, or from multiple points that capture an object (such as the person 204) from different angles.

The pipeline 600 can include an initializer 604. The initializer 604 can be included in the computing system. The initializer 604 can generate mesh layers, such as the layers 220A, 220B, 220C, 220D, based on the volumetric scene 202.

The pipeline 600 can include an updater 606. The updater 606 can be included in the computing system. The updater 606 can downsample the layers 220A, 220B, 220C, 220D into the cells 230A, 230B, 230C, 230D. In some implementations, the updater 606 generates a scoring function, generating scores for the blocks by which the k blocks are selected.

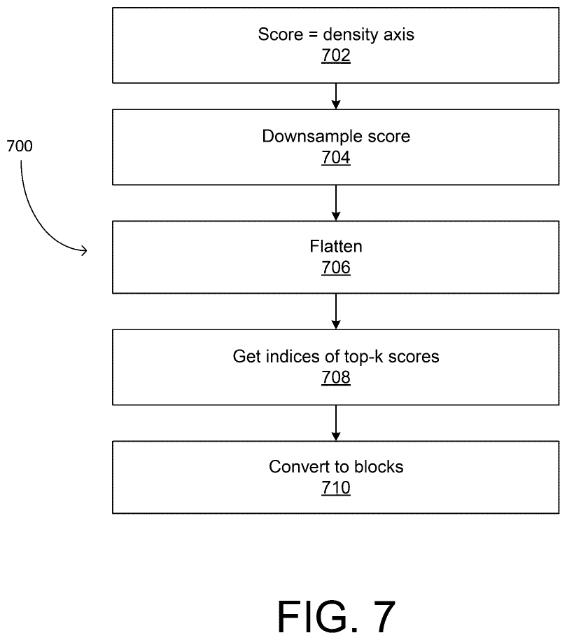

The pipeline 600 can include selected blocks 608. The pipeline 600 can generate the selected blocks, such as selected blocks 270, based on the cells 230A, 230B, 230C, 230D. The pipeline 600 can provide the selected blocks 608 to a pipeline 700 (described below with reference to FIG. 7). The pipeline 700 can provide output to a sparse updater 610.

The pipeline 600 can include a sparse updater 610. The sparse updater 610 performs convolution on the selected blocks 608. The convolution can include transforming block features in an abstract feature space and/or propagating localized information. The sparse updater 610 can include a neural network that performs the convolution on the selected blocks 608. The sparse updater 610 can generate sparsely updated blocks based on the selected blocks 608. Performing convolution on the selected blocks consumes fewer computing resources than performing convolution on all of the blocks including the empty or inactive blocks.

The pipeline 600 can include a decoder 612. The decoder 612 can be included in the computing system. The decoder 612 can reconstruct the volumetric scene 202 based on the sparsely updated selected blocks.

FIG. 7 shows a pipeline 700 for representing a volumetric scene with k selected blocks. This pipeline begins with mesh layers, such as the layers 220A, 220B, 220C, 220D, and can generate cells, such as cells 230A, 230B, 230C, 230D, and blocks within the cells. The pipeline 700 receives the selected blocks 608 from the pipeline 600.

The pipeline 700 can determine scores for the blocks (702). The pipeline 700 can determine scores for the blocks that are received from the pipeline 600. In some implementations, the scores for the blocks can be based on densities and/or density axes within the blocks. In some implementations, densities and/or density axes can be based on a number of points within the blocks indicating presence of an object. In some examples, densities and/or density axes can be based on values for the points such as color and/or opacity.

The pipeline 700 can include downsampling the scores (704) of the blocks. Downsampling the scores (704) can include applying an average-pool or max-pool operation to a density channel of a high-resolution dense mesh layer. The application of the average-pool or max-pool operation to the density channel of the high-resolution dense mesh layer can generate a single value per block region. In some examples, a window size of the average-pool or max-pool operation can be equal to a stride length.

The pipeline 700 can include flattening the blocks (706). Flattening the blocks (706) can include reshaping blocks while maintaining location date of the blocks as an auxiliary variable. The flattening the blocks (706) generates a list for getting indices at (708).

The pipeline 700 can include getting indices of the top k scores (708). The indices of the top k scores can indicate the locations of the selected blocks for which the identifiers of locations were discarded. The indices of the top k scores can be stored. Storage of the indices of the top k scores enables the locations of the selected blocks to be determined to reconstruct the volumetric scene 202.

The pipeline 700 can include converting to blocks (710). Converting to blocks can include generating the selected blocks 270, 370, 470, 570, 570A. The selected blocks 270, 370, 470, 570, 570A can be generated in association with the indices of the top k scores, enabling later reconstruction of the volumetric scene 202. The pipeline 700 can output and/or provide the generated selected blocks to the sparse updater 610 of the pipeline 600.

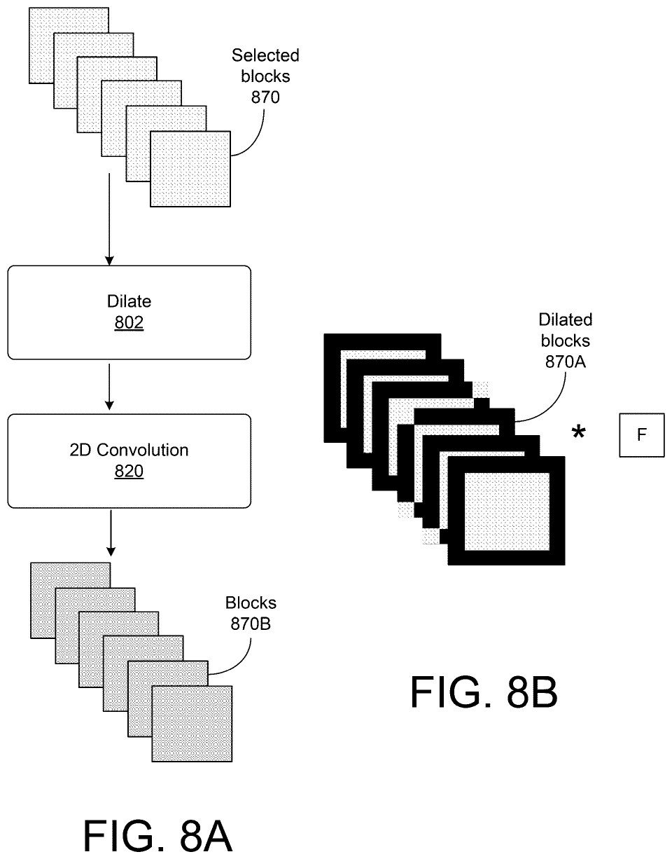

FIGS. 8A and 8B show a pipeline for performing convolution on selected blocks 870. The convolution is used in the convolutional layers of the sparse updater 610. The selected blocks 870 can have similar features as the selected blocks 270, 370, 470, 570. The pipeline, which can be included in a computing system, can dilate (802) the selected blocks 870. The dilation (802) of the selected blocks 870 can include expanding the sizes of the selected blocks 870 (such as by increasing height and width of the selected blocks 870) and adding predetermined values and/or fill values to the added portions of the selected blocks 870 to generate dilated blocks 870A, as discussed above with respect to FIG. 5. The dilation (802) appends values around borders of blocks. On edges of a block that are not bordered by and/or are not adjacent to another block, the fill value appends a fill value to the expanded portion of the dilated block. On edges of a block that are bordered by and/or are adjacent to another block, values of the block that borders and/or is adjacent to the block are appended to the block.

After the pipeline performs dilation (802), the pipeline can perform two-dimensional convolution (820) on the dilated blocks 870A. The two-dimensional convolution (820) can include applying one or more filters to the dilated blocks 870A with weights that are tunable and learned via an end-to-end training pipeline. The filter weights are parameters of the model of pipeline 600. The blocks that are inputted to and outputted from the two-dimensional convolution (820) represent multidimensional features describing the volumetric scene. The two-dimensional convolution (820) can generate blocks 870B. The blocks 870B can be versions of the selected blocks 870 that generate better images (such as representations of the volumetric scene 202) based on the two-dimensional convolution (820).

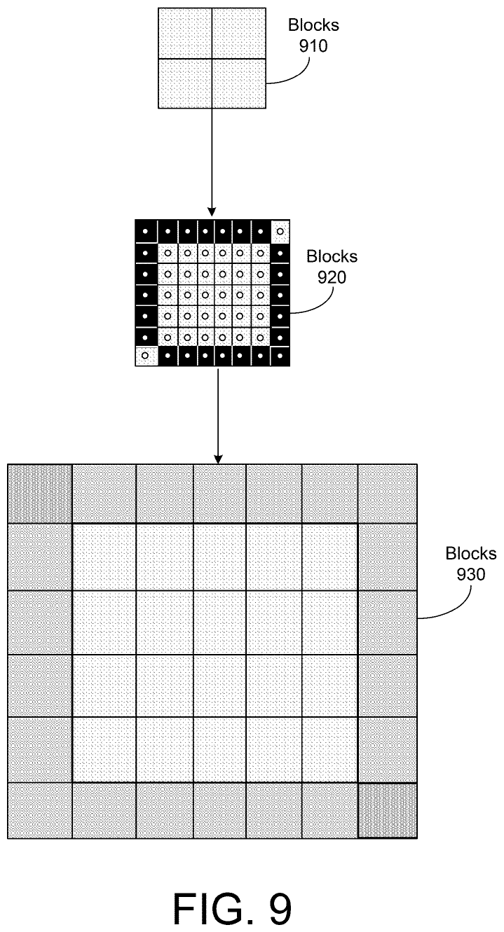

FIG. 9 shows rescaling blocks to change resolution of the blocks. This operation of rescaling blocks can receive, as input, sizes (such as height and width) of selected blocks (such as selected blocks 270, 370, 470, 570), desired output sizes (such as height and width) to which the blocks are to be rescaled, the selected blocks, and attributes and/or specifications of the selected blocks. The attributes and/or specifications can be similar to the attributes and/or specifications described above with respect to FIGS. 1, 3, and 4.

The rescaling can include dilating the blocks 910 to generate the blocks 920. Dilation can include generation of the blocks 920 based on the blocks 910 by increasing sizes and/or number of the blocks by a predetermined factor, such as tripling the number of blocks (to increase the cell size from a two-by-two cell to a six-by-six cell) and/or adding an “apron” of blocks (shown with darker shading) around the blocks. The apron of blocks is shown in FIG. 9 with darker shading around the six-by-six cell. The apron of blocks can have the predetermined values and/or fill values discussed above. The addition of the apron prevents the fill value from unintentionally leaking into the border of the block during interpolation.

The rescaling can include performing bilinear interpolation on the blocks 920 to generate blocks 930. The bilinear interpolation can include resampling values of the blocks 920 to generate blocks with the desired output sizes. In the example shown in FIG. 9, the rescaled blocks include a four-by-five cell of blocks with a surrounding apron for a six-by-seven cell of blocks.

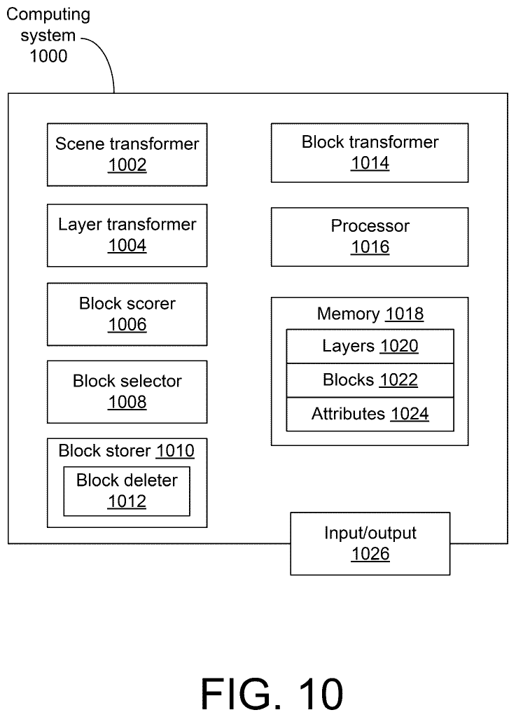

FIG. 10 shows a computing system 1000. The computing system 1000 can transform a volumetric scene into layers (102), transform the layers into blocks (104), select k of the blocks (106), store the k selected blocks (108), and/or transform the blocks into layers (110).

The computing system 1000 can include a scene transformer 1002. The scene transformer 1002 transforms a scene, such as a volumetric scene, into layers such as mesh layers. The transformation of the scene into layers can include generating the layers based on the volumetric scene. The scene transformer 1002 can, for example, transform the volumetric scene 202 into the layers 220A, 220B, 220C, 220D. The layers can include three-dimensional objects and/or shapes representing portions of the volumetric scene.

The computing system 1000 can include a layer transformer 1004. The layer transformer 1004 can transform layers, such as mesh layers, into cells and/or blocks such as mesh cells and/or mesh blocks. The blocks included in the cells can include the three-dimensional objects and/or shapes representing portions of the volumetric scene. The transformation of the layers into cells and/or blocks can include generating cells and/or blocks based on layers. An example of transforming layers into cells is the transformation of the layers 220A, 220B, 220C, 220D into the cells 230A, 230B, 230C, 230D.

The computing system 1000 can include a block scorer 1006. The block scorer 1006 can determine scores for the blocks included in the cells. The block scorer 1006 can determine the scores for the blocks based, for example, on densities of the blocks (indicating how much of an object from the volumetric scene is represented by the block), based on points included in the blocks, and/or based on values (which can indicate color and/or opacity) of points included in and/or represented by the blocks.

The computing system 1000 can include a block selector 1008. The block selector 1008 can select k blocks for storage as selected blocks. The block selector 1008 can select the k blocks based on the scores determined by the block scorer 1006. The block selector 1008 can, for example, select the k blocks with highest scores.

The computing system 1000 can include a block store 1010. The block store 1010 can store the blocks selected by the block selector 1008. The block store 1010 can store the blocks selected by the block selector 1008 as a selected blocks data structure. The block store 1010 can store the blocks in a memory 1018.

In some implementations, the block store 1010 includes a block deleter 1012. The block deleter 1012 can delete the blocks that were not selected, which can also be considered the non-selected blocks. The block deleter 1012 can delete the blocks from the memory 1018. Deleting the blocks that were not selected frees up memory and/or reduces memory consumption.

The computing system 1000 can include a block transformer 1014. The block transformer 1014 can transform the blocks generated by the layer transformer 1004 into layers. The block transformer 1014 can recreate the volumetric scene by transforming the blocks into layers and transforming the layers into a volumetric scene similar to the volumetric scene 202. The block transformer 1014 can, for example, generate blocks that do not correspond to selected blocks with fill values and/or predetermined values.

The computing system 1000 can include at least one processor 1016. The at least one processor 1016 can execute instructions, such as instructions stored in at least one memory device 1018, to cause the computing system 1000 to perform any combination of methods, functions, and/or techniques described herein.

The computing system 1000 can include at least one memory device 1018. The at least one memory device 1018 can include a non-transitory computer-readable storage medium. The at least one memory device 1018 can store data and instructions thereon that, when executed by at least one processor, such as the processor 1016, are configured to cause the computing system 1000 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing system 1000 can be configured to perform, alone, or in combination with the computing system 1000, any combination of methods, functions, and/or techniques described herein.

In some implementations, the at least one memory device 1018 stores layers 1020. Storing the layers 1020 can include storing layers, such as mesh layers, generated based on a volumetric scene. The layers 220A, 220B, 220C, 220D are examples of layers 1020 stored in the at least one memory device 1018.

In some implementations, the at least one memory device 1018 stores blocks 1022. Storing blocks 1022 can include storing blocks, such as mesh blocks, generated based on the layers that were generated based on the volumetric scene. In some implementations, the stores blocks 1022 include the selected blocks 270, 370, 470, 570, 870.

In some implementations, the at least one memory device 1018 stores attributes 1024 of the stored blocks 1022. In some implementations, the attributes 1024 include locations of the blocks, such as an integer array with a depth, row, and/or column indicating the block location. In some implementations, the attributes 1024 include a block size, such as a height and/or width of the block. In some implementations, the attributes 1024 can include full dimensions of the blocks, such as a number of layers, height, and/or width of a larger tensor or representation of the volumetric scene that the blocks index to. In some implementations, the attributes 1024 include the scores of the blocks.

The computing system 1000 may include at least one input/output node 1026. The at least one input/output node 1026 may receive and/or send data, such as from and/or to, a server, and/or may receive input and provide output from and to a user. The input and output functions may be combined into a single node, or may be divided into separate input and output nodes. The input/output node 1026 can include a microphone, a camera, an IMU, a display, a speaker, a microphone, one or more buttons, and/or one or more wired or wireless interfaces for communicating with other computing devices such as a server and/or the computing devices that captured images of the volumetric scene 202.

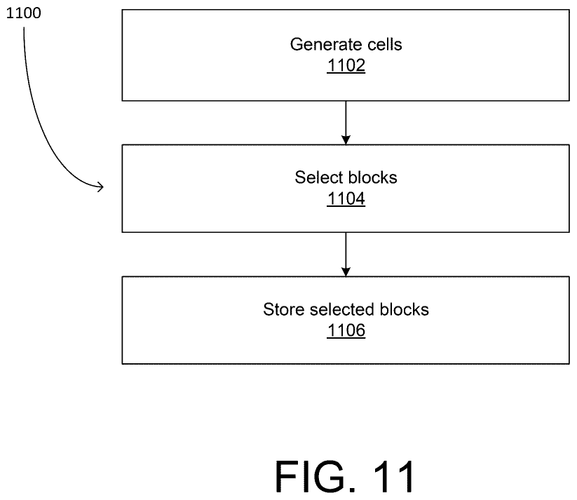

FIG. 11 is a flowchart of a method 1100. The method 1100 can be performed by a computing system such as the computing system 1000.

The method 1100 includes generating cells (1102). Generating cells (1102) can include generating multiple mesh cells based on multiple mesh layers, the multiple mesh layers representing a volumetric scene, the multiple mesh cells including multiple mesh blocks. The method 1100 includes selecting blocks (1104). Selecting blocks (1104) can include selecting, from the multiple mesh blocks, k selected blocks based on densities of the multiple mesh blocks, k being a predetermined number. The method 1100 includes storing the selected blocks (1106). Storing the selected blocks (1106) can include storing the selected blocks and identifiers of locations of the selected blocks.

In some examples, the method 1100 further includes deleting non-selected blocks, the non-selected blocks being the multiple mesh blocks other than the selected blocks.

In some examples, the storing (1106) includes storing the selected blocks, identifiers of locations of the selected blocks, and sizes of the selected blocks.

In some examples, the storing (1106) further includes storing a number of the multiple mesh layers.

In some examples, the storing (1106) further includes storing a score associated with each of the selected multiple mesh blocks, the score indicating the density of the selected block.

In some examples, the method 1100 further includes generating multiple new mesh layers based on the selected blocks and a predetermined value for mesh blocks within the multiple new mesh layers that do not correspond to the selected blocks.

In some examples, the method 1100 further includes generating an array of layers based on the selected blocks and expanding sizes of the selected blocks.

In some examples, the multiple mesh layers are each different distances from a reference point.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A non-transitory computer-readable storage medium comprising instructions stored thereon that, when executed by at least one processor, are configured to cause a computing system to at least:
generate multiple mesh cells based on multiple mesh layers, the multiple mesh layers representing a volumetric scene, the multiple mesh cells including multiple mesh blocks;
select, from the multiple mesh blocks, k selected blocks based on densities of the multiple mesh blocks, k being a predetermined number; and
store the selected blocks and identifiers of locations of the selected blocks.

2. The non-transitory computer-readable storage medium of claim 1, wherein the instructions are further configured to cause the computing system to delete non-selected blocks, the non-selected blocks being the multiple mesh blocks other than the selected blocks.

3. The non-transitory computer-readable storage medium of claim 1, wherein the storing includes storing the selected blocks, identifiers of locations of the selected blocks, and sizes of the selected blocks.

4. The non-transitory computer-readable storage medium of claim 1, wherein the storing further includes storing a number of the multiple mesh layers.

5. The non-transitory computer-readable storage medium of claim 1, wherein the storing further includes storing a score associated with each of the selected multiple mesh blocks, the score indicating the density of the selected block.

6. The non-transitory computer-readable storage medium of claim 1, wherein the instructions are further configured to cause the computing system to generate multiple new mesh layers based on the selected blocks and a predetermined value for mesh blocks within the multiple new mesh layers that do not correspond to the selected blocks.

7. The non-transitory computer-readable storage medium of claim 1, wherein the instructions are further configured to cause the computing system to generate an array of layers based on the selected blocks and expanding sizes of the selected blocks.

8. The non-transitory computer-readable storage medium of claim 1, wherein the multiple mesh layers are each different distances from a reference point.

9. A method comprising:
generating multiple mesh cells based on multiple mesh layers, the multiple mesh layers representing a volumetric scene, the multiple mesh cells including multiple mesh blocks;
selecting, from the multiple mesh blocks, k selected blocks based on densities of the multiple mesh blocks, k being a predetermined number; and
storing the selected blocks and identifiers of locations of the selected blocks.

10. The method of claim 9, further comprising deleting non-selected blocks, the non-selected blocks being the multiple mesh blocks other than the selected blocks.

11. The method of claim 9, wherein the storing includes storing the selected blocks, identifiers of locations of the selected blocks, and sizes of the selected blocks.

12. The method of claim 9, wherein the storing further includes storing a number of the multiple mesh layers.

13. The method of claim 9, wherein the storing further includes storing a score associated with each of the selected multiple mesh blocks, the score indicating the density of the selected block.

14. The method of claim 9, further comprising generating multiple new mesh layers based on the selected blocks and a predetermined value for mesh blocks within the multiple new mesh layers that do not correspond to the selected blocks.

15. The method of claim 9, further comprising generating an array of layers based on the selected blocks and expanding sizes of the selected blocks.

16. The method of claim 9, wherein the multiple mesh layers are each different distances from a reference point.

17. A computing system comprising:
at least one processor; and
a non-transitory computer-readable storage medium comprising instructions stored thereon that, when executed by the at least one processor, are configured to cause the computing system to at least:
generate multiple mesh cells based on multiple mesh layers, the multiple mesh layers representing a volumetric scene, the multiple mesh cells including multiple mesh blocks;
select, from the multiple mesh blocks, k selected blocks based on densities of the multiple mesh blocks, k being a predetermined number; and
store the selected blocks and identifiers of locations of the selected blocks.

18. The computing system of claim 17, wherein the storing includes storing the selected blocks, identifiers of locations of the selected blocks, and sizes of the selected blocks.

19. The computing system of claim 17, wherein the instructions are further configured to cause the computing system to generate multiple new mesh layers based on the selected blocks and a predetermined value for mesh blocks within the multiple new mesh layers that do not correspond to the selected blocks.

20. The computing system of claim 17, wherein the instructions are further configured to cause the computing system to generate an array of layers based on the selected blocks and expanding sizes of the selected blocks.
